(19) United States
(12) Patent Application Publication
(10) Pub. No.: US 2017/0067723 A1
(43) Pub. Date: Mar. 9, 2017

(54) Devices and Methods for Attaching an Arrowhead to an Arrow Shaft

(71) Applicant: FeraDyne Outdoors LLC, Superior, WI (US)

(72) Inventors: William Edward Pedersen, Duluth, MN (US); Jon Arthur Syverson, Cloquet, MN (US); Ryan Chalupsky, Duluth, MN (US)

(73) Assignee: FeraDyne Outdoors LLC, Superior, WI (US)

(21) Appl. No.: 15/256,687

(22) Filed: Sep. 5, 2016

Related U.S. Application Data
(60) Provisional application No. 62/214,336, filed on Sep. 4, 2015.

(51) Int. Cl. F42B 6/08; B29C 65/48; B29C 65/56; F42B 6/04; B29C 45/00

(52) U.S. Cl. CPC F42B 6/08; F42B 6/04; B29C 45/0013; B29C 65/561; B29C 65/4805; B29L 2001/00

(57) ABSTRACT

Insert-outsert devices and methods of using those devices to attach an arrowhead to an arrow shaft. The insert-outsert device can be inserted into an arrow shaft, and a threaded end of an arrowhead can be screwed through a hollow threaded portion of the outsert and into the insert. The device structurally reinforces the arrow at a region of connection between the arrow shaft and arrowhead, reducing the likelihood that the arrow shaft will buckle or break under the axial and/or bending forces exerted when an arrow strikes a target.

### CROSS-REFERENCE TO RELATED APPLICATIONS

This application claims the benefit of U.S. Provisional Patent Application No. 62/214,336 filed Sep. 4, 2015, which is herein incorporated by reference in its entirety.

### FIELD OF THE INVENTION

Embodiments of the present invention generally relate to devices and methods for attaching arrowheads to arrow shafts and to reinforcing the structural integrity of the arrow shaft at the connection between the arrowhead and arrow shaft. More particularly, embodiments of the invention are directed to devices including a cylindrical insert for insertion into an arrow shaft and an outsert into which the cylindrical insert, the arrow shaft, and an arrowhead are all inserted.

### BACKGROUND OF THE INVENTION

When bowhunting, archers commonly use arrows that include an arrow shaft and an arrowhead that is inserted into the shaft. The location where the arrowhead is inserted into the arrow shaft, connecting the two components, is potentially subject to a number of different forces.

For example, when a carbon composite arrow (especially a smaller diameter arrow) strikes a target, bending and compressional forces can result in compressional or buckling failure of the arrow's carbon fibers at the location where the arrowhead is inserted into the arrow shaft.

Existing devices for reinforcing the attachment point of an arrowhead to an arrow shaft also suffer from certain deficiencies. For example, these devices can add excessive weight to the arrow, and adversely affect both the airflow around the arrow in flight and the aerodynamics of the arrow.

We have discovered that there is a need for reducing the weight of a device for attaching an arrowhead to an arrow shaft, so that the device provides structural support at the arrowhead-arrow shaft juncture, and does not substantially affect the airflow around the arrow in flight or the aerodynamics of the arrow.

### SUMMARY OF EMBODIMENTS OF THE INVENTION

Embodiments of the invention are directed to devices for attaching an arrowhead to an arrow shaft and that include an outsert that includes a hollow threaded portion and a cylindrical insert that includes a hollow portion. In certain embodiments, the outsert is made of a ceramic, a composite, or a metal alloy such as steel, stainless steel, an aluminum alloy, a titanium alloy, or a magnesium alloy.

In certain embodiments, the cylindrical insert is made of a polymer such as a nylon, acrylonitrile butadiene styrene (ABS) plastic, polyethylene, polypropylene, or polyoxymethylene (POM). In certain embodiments, the cylindrical insert is molded to the outsert. In certain embodiments, the cylindrical insert includes a solid cylindrical portion. In certain embodiments, the cylindrical insert extends past an edge of the outsert.

In certain embodiments, an interior of the hollow portion of the cylindrical insert is unthreaded. In certain embodiments, an inner diameter of the hollow portion of the cylindrical insert is between approximately 0.135 inches and approximately 0.150 inches. In certain embodiments, an outer diameter of the cylindrical insert is between approximately 0.165 inches and approximately 0.210 inches.

In certain embodiments, the outsert is secured to the cylindrical insert by an adhesive and/or a friction fit. In certain further embodiments, the adhesive is an epoxy, a hot-melt, a cyanoacrylate, or a urethane. In certain embodiments, the outsert includes a first hollow cylindrical portion on a first side of the hollow threaded portion and a second hollow cylindrical portion on a second side of the hollow threaded portion. In certain further embodiments, the first hollow cylindrical portion has an inner diameter between approximately 0.25 inches and approximately 0.36 inches, and the second hollow cylindrical portion has an inner diameter between approximately 0.135 inches and approximately 0.150 inches. In certain further embodiments, a thickness of the cylindrical insert is between approximately 0.010 inches and approximately 0.040 inches.

Embodiments of the invention are directed to methods for manufacturing a device for attaching an arrowhead to an arrow shaft, including injection molding a polymer into an outsert including a hollow threaded portion, a first hollow cylindrical portion on a first side of the hollow threaded portion, and a second hollow cylindrical portion on a second side of the hollow threaded portion, wherein the injection-molded polymer forms a cylindrical insert bonded to an interior of the second hollow cylindrical portion of the outsert. In certain embodiments, the outsert is made of steel, stainless steel, an aluminum alloy, a titanium alloy, or a magnesium alloy.

In certain embodiments, the injection-molded polymer is a nylon, acrylonitrile butadiene styrene (ABS) plastic, polyethylene, polypropylene, or polyoxymethylene (POM). In certain further embodiments, injection molding the polymer includes dispersing particles of lead, bismuth, or tungsten throughout the polymer.

Embodiments of the invention are directed to methods for attaching an arrowhead to an arrow shaft, including inserting a cylindrical insert into the arrow shaft, inserting the arrow shaft into a first hollow cylindrical portion of an outsert, inserting the arrowhead into a second hollow cylindrical portion of the outsert, and screwing a threaded portion of the arrowhead into a hollow threaded portion of the outsert.

In certain embodiments, the method includes tapping a hollow portion of the cylindrical insert by screwing the threaded portion of the arrowhead into the hollow portion of the cylindrical insert. In certain embodiments, the method includes securing the cylindrical insert to the outsert with an adhesive such as an epoxy, a hot-melt, a cyanoacrylate, or a urethane. In certain embodiments, the method includes securing the cylindrical insert to the outsert to the arrow shaft with an adhesive such as an epoxy, a hot-melt, a cyanoacrylate, or a urethane.

Embodiments of the invention are directed to methods for attaching an arrowhead to an arrow shaft, including inserting the arrow shaft into a first hollow cylindrical portion of an outsert, the first hollow cylindrical portion of the outsert containing an injection-molded polymer insert, inserting the arrowhead into a second hollow cylindrical portion of the outsert, and screwing a threaded portion of the arrowhead into a hollow threaded portion of the outsert.

In certain embodiments, the method includes tapping a hollow portion of the injection-molded polymer insert by screwing the threaded portion of the arrowhead into the hollow portion of the injection-molded polymer insert. In certain embodiments, the method includes securing both the injection-molded polymer insert and the outsert to the arrow shaft with an adhesive such as an epoxy, a hot-melt, a cyanoacrylate, or a urethane.

### BRIEF DESCRIPTION OF THE DRAWINGS

FIG. 1 is a see-through perspective view of a first embodiment of a cylindrical insert, where the cylindrical insert includes a hollow portion.

FIG. 2 is a see-through perspective view of a second embodiment of a cylindrical insert, where the cylindrical insert includes a hollow portion.

FIG. 3 is a see-through perspective view of a third embodiment of a cylindrical insert, where the cylindrical insert includes both a hollow portion and a solid cylindrical portion.

FIG. 4 is a see-through perspective view of an embodiment of an outsert, the outsert including a first hollow cylindrical portion, a hollow threaded portion, and a second hollow cylindrical portion.

FIG. 5A is a side view of a fixed-blade broadhead being inserted into the embodiment of a cylindrical insert depicted in FIG. 1 and the embodiment of an outsert depicted in FIG. 4, the cylindrical insert being inserted into an arrow shaft, and the arrow shaft and cylindrical insert being inserted into the outsert.

FIG. 5B is a side view of the fixed-blade broadhead, cylindrical insert and outsert, and arrow shaft depicted in FIG. 5A, with the cylindrical insert inserted into the arrow shaft.

FIG. 5C is a side view of the fixed-blade broadhead, cylindrical insert and outsert, and arrow shaft depicted in FIG. 5B, with the cylindrical insert and arrow shaft inserted into the outsert.

FIG. 5D is a side view of the fixed-blade broadhead, cylindrical insert and outsert, and arrow shaft depicted in FIG. 5C, with the arrowhead inserted into the outsert and cylindrical insert.

FIG. 5E is a cross-section of the fixed-blade broadhead, cylindrical insert and outsert, and arrow shaft depicted in the side view of FIG. 5D.

FIG. 6 is a cross-sectional side view of an arrow assembly that includes a narrow-point arrowhead, the embodiment of a cylindrical insert depicted in FIG. 1, the embodiment of an outsert depicted in FIG. 4, and an arrow shaft.

FIG. 7 is a cross-sectional side view of an arrow assembly that includes a narrow-point arrowhead, the embodiment of a cylindrical insert depicted in FIG. 2, the embodiment of an outsert depicted in FIG. 4, and an arrow shaft.

FIG. 8 is a cross-sectional side view of an arrow assembly that includes a narrow-point arrowhead, the embodiment of a cylindrical insert depicted in FIG. 3, the embodiment of an outsert depicted in FIG. 4, and an arrow shaft.

FIG. 9 is a cross-sectional view of an embodiment of an outsert into which a cylindrical insert has been molded.

FIG. 10A is a side view of a narrow-point arrowhead and an arrow shaft being inserted into the embodiment of an insert-outsert device depicted in FIG. 9.

FIG. 10B is a side view of the narrow-point arrowhead, arrow shaft, and insert-outsert depicted in FIG. 10A, with the arrow shaft inserted into the insert-outsert device.

FIG. 10C is a side view of the arrowhead, arrow shaft, and insert-outsert depicted in FIG. 10B, with the arrowhead inserted into the insert-outsert device.

FIG. 11 is a see-through perspective view of an embodiment of a cylindrical insert, the cylindrical insert including protrusions on its outer surface.

FIG. 12 is a perspective view of an embodiment of an outsert, the outsert including grooves on its outer surface.

### DETAILED DESCRIPTION OF THE INVENTION

Embodiments of the invention pertain to designs for devices that attach an arrowhead to an arrow shaft. The term “arrow” encompass both conventional arrows as well as bolts for use with crossbows. The term “arrowhead” encompass arrowheads for use in conventional arrow shafts, as well as bolt heads for insertion into a crossbow bolt. The term “arrow shaft” encompass both conventional arrow shafts as well as crossbow bolt shafts. The arrowheads utilized with the devices and methods of the present invention may be narrow-point arrowheads or broadheads, including both fixed and expandable broadheads. The devices and methods of the present invention are readily adaptable to fixed broadheads having fixed cutting blades (for example, three or four fixed cutting blades), and can similarly be used with expandable broadheads having two or three deployable blades and a chisel or scalpel tip.

In some embodiments, the devices include both a cylindrical insert and an outsert. Various embodiments of cylindrical inserts 100, 200, and 300 are depicted, respectively, in FIGS. 1-3. The cylindrical inserts 100, 200, and 300 are designed to be inserted into an arrow shaft (not shown), and to receive a threaded portion of an arrowhead (not shown) that is inserted into the cylindrical insert.

In embodiments of the invention, the arrow shafts may have an inner diameter of between approximately 0.166 inches to approximately 0.207 inches, and an outer diameter of between approximately 0.250 inches and approximately 0.3125 inches. However, arrow shafts come in a variety of sizes, and the insert and outsert devices can be sized to fit within arrow shafts having a variety of sizes, including smaller or larger inner and outer diameters. For example, in various embodiments, an arrow shaft may have a diameter of approximately ¼ inches, approximately 9/32 inches, approximately 5/16 inches, approximately 21/64 inches, approximately 11/32 inches, or approximately 23/64 inches.

In some embodiments, the cylindrical inserts 100, 200, and 300 are sized to fit snugly, such as by using a friction fit, within an inner bore of an arrow shaft, and to receive a threaded portion of an arrowhead that is inserted into the cylindrical insert. In some embodiments, the cylindrical insert 100, 200, or 300 has an inner diameter approximately equal to the pitch diameter of an 8-32 UNC threaded fastener portion of an arrowhead (or between approximately 0.135 inches and approximately 0.150 inches). In these embodiments, the cylindrical insert 100, 200, and 300 can be secured to the inner bore of the arrow shaft by using a friction fit between cylindrical insert 100, 200, or 300 and the inner bore of the arrow shaft, by using an adhesive such as an epoxy, a hot-melt, a cyanoacrylate, or a urethane, or by using both a friction fit and an adhesive.

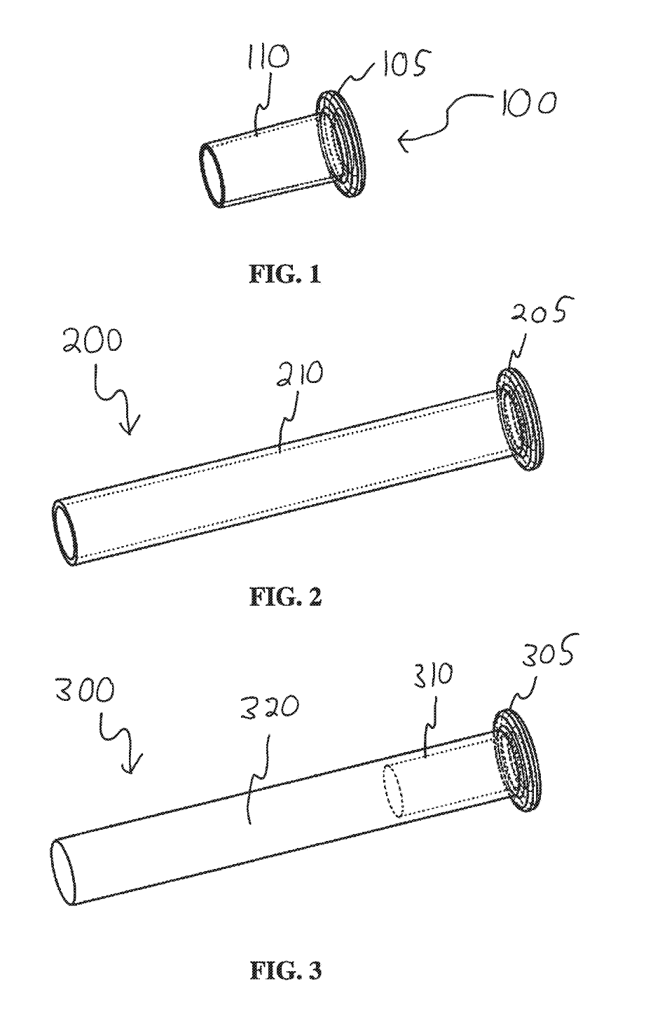

The cylindrical inserts 100, 200, and 300 include a hollow portion 110 for receiving a threaded portion of the arrowhead, as depicted by a cylindrical hollow portion within the dashed lines in FIG. 1, a cylindrical hollow portion 210 within the dashed lines in FIG. 2, and a cylindrical hollow portion 310 within dashed lines in FIG. 3. Cylindrical insert 300 also includes a solid cylindrical portion 320.

Cylindrical insert 100 includes a collar 105 on one end of the cylindrical insert 100. The collar 105 has a larger outer diameter than the hollow portion 110 of cylindrical insert 100, and is designed to rest on the edge of the arrow shaft that the insert 100 is inserted into, thereby preventing cylindrical insert 100 from moving deeper into the arrow shaft. Similarly, cylindrical insert 200 includes collar 205, and cylindrical insert 300 includes collar 305.

In some embodiments, the hollow portions 110, 210, and 310 of the cylindrical inserts 100, 200, and 300 are unthreaded, and have a smooth interior wall. In these embodiments, the cylindrical inserts 100, 200, and 300 are preferably manufactured from a soft, compliant material that allows the threaded portion of the arrowhead to “tap” (or self-thread) into the interior wall of the cylindrical insert 100, 200, or 300, forming threads in the material of the cylindrical insert 100, 200, or 300 as the arrowhead is screwed into the hollow portion 110, 210, or 310 of the cylindrical insert 100, 200, or 300, securing the arrowhead to cylindrical insert 100, 200, or 300 by providing a friction fit between the compliant material of the insert 100, 200, or 300 and the threads of the arrowhead.

The cylindrical inserts 100, 200, and 300 can be manufactured from, for example, a nylon or from acrylonitrile butadiene styrene (ABS) plastic. Both nylon and ABS plastic can be utilized to manufacture a cylindrical insert with smooth, unthreaded interior walls, which allows a threaded portion of an arrowhead to self-thread into the smooth walls of the cylindrical insert 100, 200, and 300. Such a cylindrical insert 100, 200, and 300, when manufactured from either nylon or ABS plastic, is lightweight (so as to not substantially affect the airflow around the arrow in flight or the aerodynamics of the arrow), but has sufficient strength to structurally reinforce an inner bore of an arrow shaft into which it is inserted.

A cylindrical insert 100, 200, and 300 manufactured from ABS plastic will bond well with adhesives such as an epoxy, a hot-melt, a cyanoacrylate, and a urethane. In contrast, a cylindrical insert 100, 200, and 300 manufactured from nylon may only bond well with a subset of the adhesives that can be used with an insert manufactured from ABS plastic, but the nylon cylindrical insert may be more effective in self-threading an arrowhead into the nylon cylindrical insert than an ABS plastic cylindrical insert would be. In other embodiments of the invention, the cylindrical insert 100, 200, and 300 may be manufactured from another polymer, such as polyethylene, polypropylene, polytetrafluoroethylene (PTFE), or polyoxymethylene (POM).

In some embodiments, instead of threading the unthreaded cylindrical insert 100, 200, or 300 with the arrowhead itself, a conventional threading tool may be used to tap/thread the unthreaded cylindrical insert 100, 200, and 300. For example, the tool may include a replica of the threaded portion of an arrowhead attached to a handle, which allows a user to screw the threaded portion of the tool into the unthreaded cylindrical insert 100, 200, or 300 to tap the walls of cylindrical insert 100, 200, or 300 and prepare cylindrical insert 100, 200, or 300 to receive the threaded portion of an arrowhead.

In addition to structurally reinforcing the an inner bore of an arrow into which they are inserted, cylindrical inserts 100, 200, and 300 may also advantageously be used to allow the weight distribution of the arrow shaft, so that the shaft has a center of mass that is closer to a tip end of the arrow shaft (where cylindrical insert 100, 200, and 300 is inserted) than a tail end of the arrow shaft. Such a shaft is referred to as a shaft that is “front of center.” In these embodiments, the polymeric material of cylindrical insert 100, 200, or 300 may have relatively heavier metal particles (such as lead, tungsten, or bismuth) dispersed throughout the material of cylindrical insert 100, 200, or 300, adding weight to cylindrical insert 100, 200, or 300. Such metal particles can be dispersed, for example, during an injection molding process.

The greater the amount of metal particles dispersed in the material of cylindrical insert 100, 200, or 300, the heavier the cylindrical insert 100, 200, or 300, making the arrow shaft into which cylindrical insert 100, 200, or 300 is inserted relatively more forward of center. Correspondingly, insert 300, which is longer and made up of a greater volume of material than insert 100, would have more mass and greater weight in comparison to insert 100 (assuming that both inserts 100 and 300 were manufactured from the same type of material).

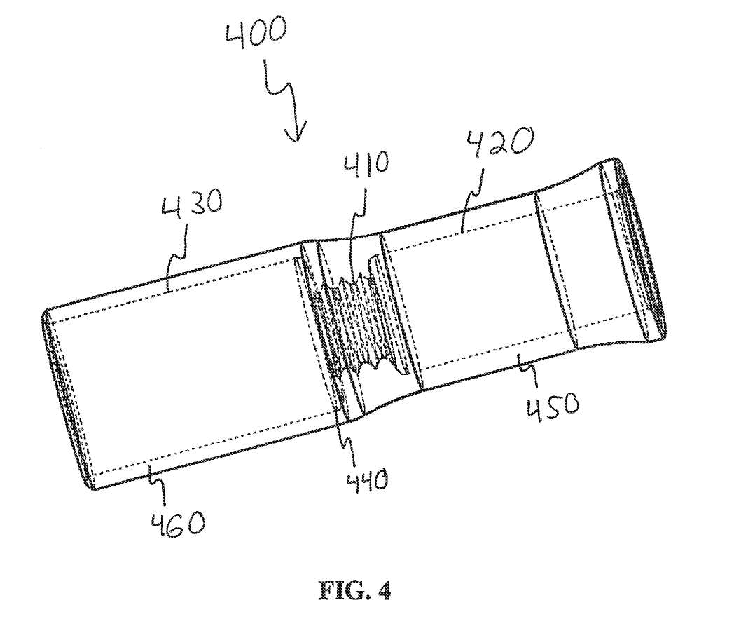

An embodiment of an outsert 400 is shown in FIG. 4. The outsert 400 includes a first hollow cylindrical portion 420 for receiving an arrowhead ferrule, a hollow threaded portion 410 for receiving a threaded portion of an arrowhead, and a second hollow cylindrical portion 430 for receiving an arrow shaft having an inner bore into which a cylindrical insert has been inserted (such as inserts 100, 200, and 300 as depicted in FIGS. 1-3). Therefore, the second hollow cylindrical portion 430 of the outsert 400 simultaneously surrounds and contacts an arrow shaft (not shown) which, in turn, surrounds a cylindrical insert (not shown) that has been inserted into the inner bore of that arrow shaft. The arrow shaft and cylindrical insert are inserted into the second hollow cylindrical portion 430 until they make contact with an end 440 of the second hollow cylindrical portion 430.

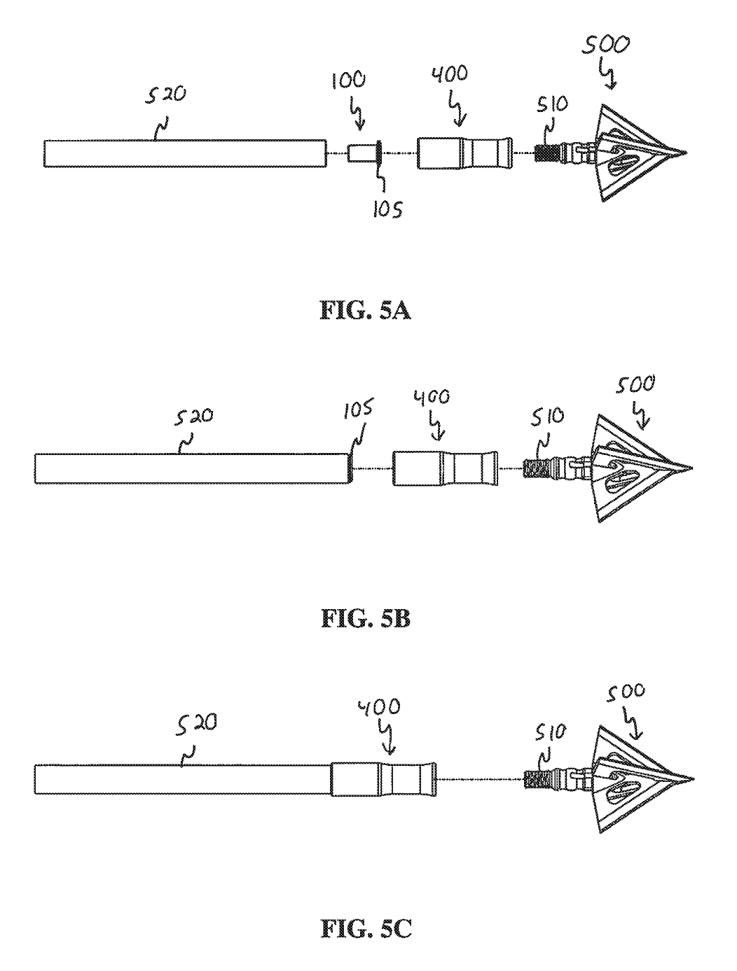

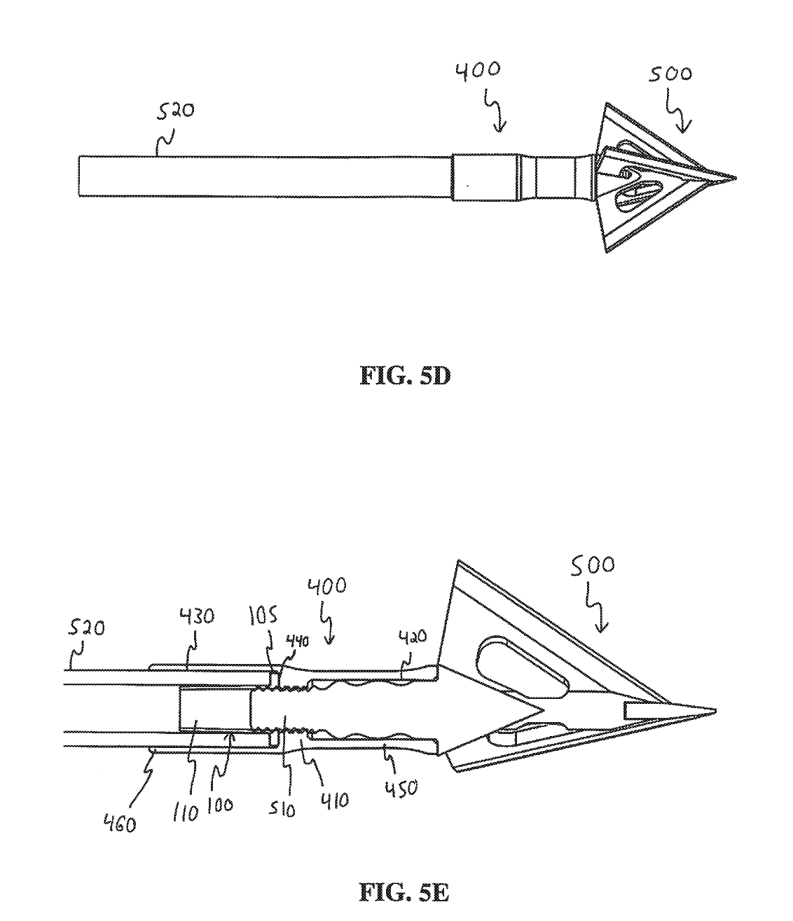

The outsert 400 can be manufactured from a ceramic (such as a toughened ceramic), a composite (such as a carbon fiber composite), or a metal alloy (including steel, stainless steel, an aluminum alloy, a titanium alloy, and a magnesium alloy). These materials have sufficient strength and a sufficient stiffness-to weight ratio so that the walls 450 and 460 of the outsert 400 are capable of withstanding axial impact loads exerted on the outsert 400 when an arrow on which the outsert 400 is mounted strikes a target. The walls 450 and 460 of outsert 400 are preferably kept as thin as possible to reduce the weight of outsert 400 to minimize any affects pertaining to airflow around the arrow in flight or the aerodynamics of the arrow. The outsert 400 can be bound to the insert (100, 200, and 300) and/or to an arrow shaft 520 (FIG. 5) by way of friction fit and/or with adhesives such as an epoxy, a hot-melt adhesive, a cyanoacrylate, and a urethane.

The hollow threaded portion 410 preferably has relatively few threads in comparison to the threaded portion of the arrowhead, so that the arrowhead will tap/self-thread the unthreaded cylindrical insert that the threaded portion of the arrowhead enters after being screwed through the hollow threaded portion 410. In embodiments that have an unthreaded cylindrical insert, timing of the threads between the hollow threaded portion 410 and the cylindrical insert will not be required—meaning that threads of the hollow threaded portion 410 and cylindrical insert do not have to be perfectly aligned before the arrowhead is screwed into the hollow threaded portion 410 (and then the insert) to prevent binding of the threads, because the threads on the interior of the hollow portion of the cylindrical insert will not exist until the cylindrical insert is tapped by the threaded portion of the arrowhead.

The outsert 400 also includes a first hollow cylindrical portion 420 for receiving the arrowhead that is screwed into the hollow threaded portion 410 of the outsert 400 and then into the cylindrical insert, and a second hollow cylindrical portion 430 for receiving an arrow shaft (as well as the cylindrical insert that is inserted into the inner bore of the arrow shaft). Therefore, the outsert 400, in combination with the cylindrical insert, secures the arrow shaft and arrowhead together to form an arrow that is structurally reinforced at the connection between the arrow shaft and arrowhead.

As illustrated by FIGS. 5A-5E, once the cylindrical insert 100 has been inserted into (and bound to) arrow shaft 520, and the insert 100 and arrow shaft 520 are inserted into (and bound to) the second hollow cylindrical portion 430 of outsert 400, the threaded portion 510 of fixed broadhead arrowhead 500 is inserted into the first hollow cylindrical portion 420 of outsert 400, and screwed through the hollow threaded portion 410 of outsert 400 and self-threads into the hollow portion 110 of cylindrical insert 100, securing the fixed broadhead arrowhead 500 within arrow shaft 520.

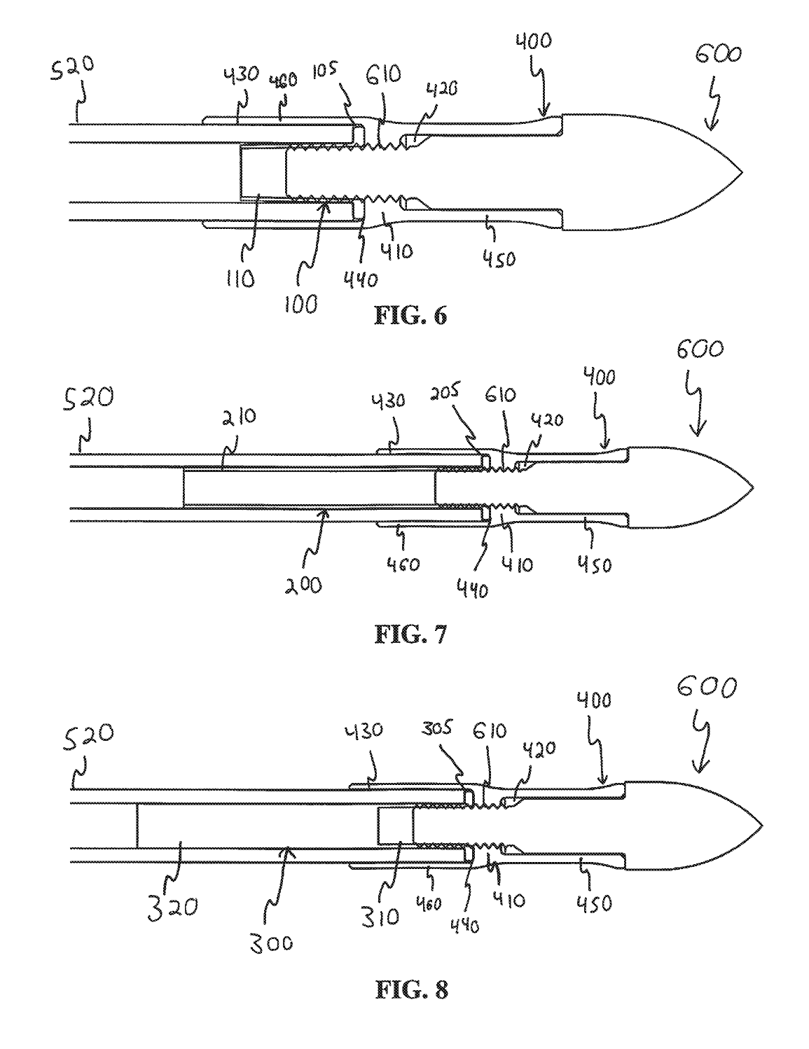

FIGS. 6-8 illustrate embodiments of a cylindrical insert 100 and outsert 400 that secure a narrow-point arrowhead 600 to an arrow shaft 520. As shown in FIG. 6, threaded portion 610 of arrowhead 600 has been screwed through hollow threaded portion 410 of outsert 400 (FIG. 4) and self-threaded into the hollow portion 110 of cylindrical insert 100 (FIG. 1). Cylindrical insert 100 has been inserted into an inner bore of arrow shaft 520, and the arrow shaft 520 and cylindrical insert 100 are inserted within the second hollow cylindrical portion 430 of outsert 400. Similarly, as shown in FIG. 7, threaded portion 610 of arrowhead 600 has been screwed through hollow threaded portion 410 of outsert 400 (FIG. 4) and self-threaded into the hollow portion 210 of cylindrical insert 200 (FIG. 2), which has been inserted into the inner bore of arrow shaft 520. And as shown in FIG. 8, threaded portion 610 of arrowhead 600 has been screwed through hollow threaded portion 410 of outsert 400 (FIG. 4) and self-threaded into the hollow portion 310 of insert 300 (FIG. 3), which has been inserted into the inner bore of arrow shaft 520.

When the arrowhead 600 depicted in FIG. 6 strikes a target, the target will exert an axial impact force on the arrowhead 600 which will be transferred from the arrowhead 600 to the outsert 400, and then from the outsert 400 to the arrow shaft 520 in three different ways. The first path through which the axial impact force is transmitted to arrow shaft 520 is through the adhesive and/or friction fit which secures the outsert 400 to the outer diameter of arrow shaft 520. The second path is from outsert 400 to the collar 105 of cylindrical insert 100, and from the collar 105 to the arrow shaft 520. The third path is from outsert 400 to the collar 105 of cylindrical insert 100, and from the walls of the cylindrical insert 100 to arrow shaft 520. The wall 450 of the outsert 400 that surrounds arrowhead 600 will typically be the weakest portion of outsert 400, and the outsert 400 can be designed using, for example, a ceramic, a composite (such as a carbon fiber composite), or a metal alloy capable of withstanding the axial impact force.

In addition to the axial impact forces described above, if the arrowhead 600 strikes a target at a non-orthogonal angle, that target will exert bending forces on the narrow-point arrowhead 600 and arrow shaft 520. In such a situation, the outsert 400 and insert 100 can be designed to provide sufficient combined support to distribute the load from the bending forces over a sufficient portion of arrow shaft 520 to prevent the arrow shaft 520 from failing due to the bending forces.

The most likely scenario for failure of an arrow shaft 520 that has been subjected to the bending forces described above results from compressional/buckling failure of the outer fibers of the arrow—specifically, at the outer portion of the arrow shaft 520 located just beyond the bottom edge of the outsert 400 on the outer diameter of the arrow shaft 520. Therefore, as shown in FIG. 7, the insert 200 extends beyond the edge of outsert 400 in the inner bore of arrow shaft 520, which provides additional support to arrow shaft 520 at the bottom edge of outsert 400 to reinforce the arrow shaft 520 against bending forces at that location. FIG. 8 shows another embodiment in which the insert 300 extends beyond the edge of outsert 400 in the inner bore of arrow shaft 520. Insert 300 has a solid cylindrical portion 320 that provides additional structural support to the arrow shaft 520 to resist the bending forces that are exerted when the arrow shaft 520 strikes a target at a non-orthogonal angle.

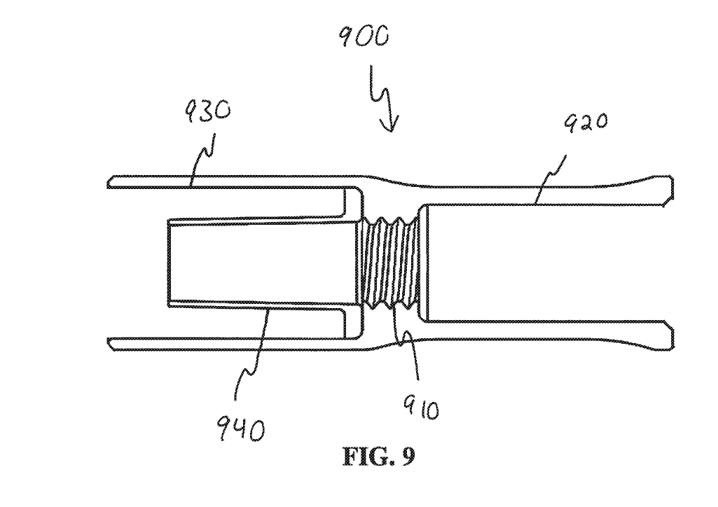

In some embodiments, instead of the insert 100, 200, 300 and outsert 400 being manufactured separately and the insert 100, 200, 300 later inserted into (and adhered to) the outsert 400, the insert 100, 200, 300 is manufactured as an integral portion of the outsert 400. For example, after manufacturing an outsert device 400 as shown in FIG. 4, a designer may injection mold a polymer directly into second hollow cylindrical portion 430 of outsert 400. FIG. 9 depicts such an integrated insert-outsert device 900, in which a polymeric insert 940 has been injection molded directly into the second hollow cylindrical portion 930 of the insert-outsert device 900.

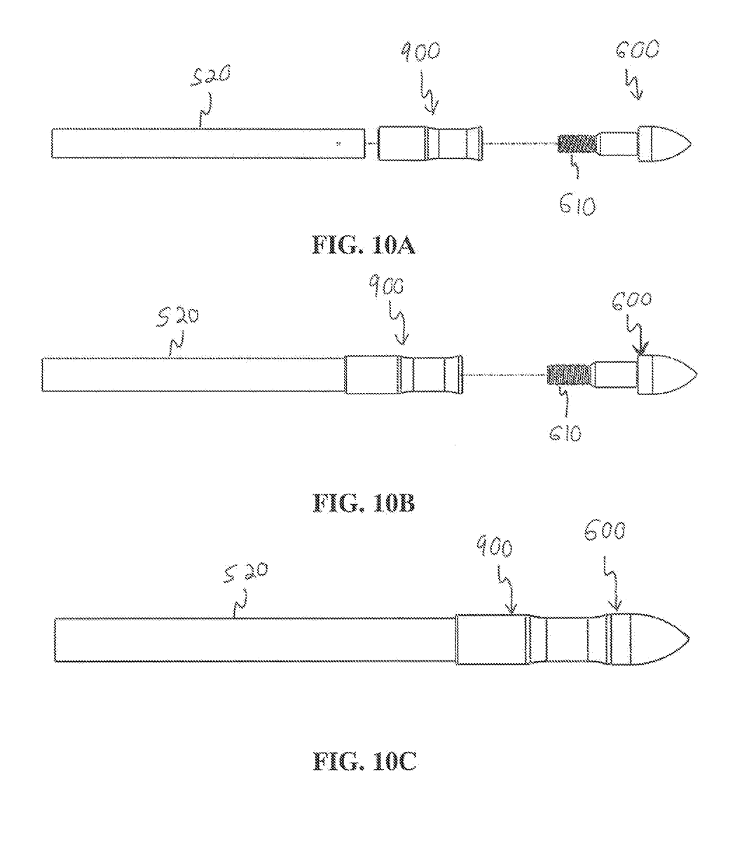

An arrowhead can be inserted into first hollow cylindrical portion 920 of the insert-outsert device 900, screwed through hollow threaded portion 910 of the insert-outsert device 900, and self-threaded into injection-molded insert 940 of the integral insert-outsert device 900. This is illustrated by the embodiment shown in FIGS. 10A-10C, which show: 1) arrow shaft 520 being inserted into the integral insert-outsert device 900. Arrow shaft 520 can also be secured to the integral insert-outsert device 900 using a friction fit and/or an adhesive); and 2) the threaded portion 610 of arrowhead 600 being inserted and screwed into integral insert-outsert device 900. After being secured together during this assembly process, the arrow shaft 520, integral-outsert device 900, and arrowhead 600 depicted in FIGS. 10A-10C are arranged in a similar manner as the embodiment depicted in FIG. 6.

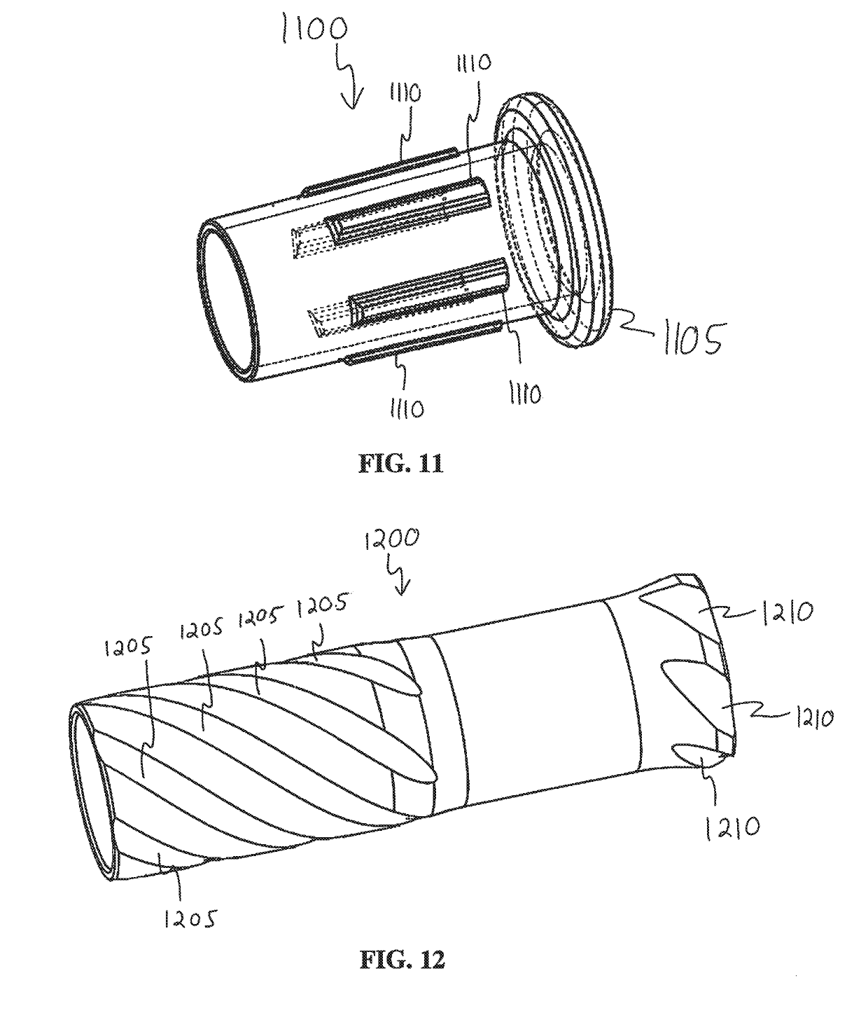

FIG. 11 shows a cylindrical insert 1100 that has a collar 1105, and an outer surface that includes protrusions 1110, such as slots or ribs, that facilitate securing the cylindrical insert 1100 to the inner bore of the arrow shaft.

FIG. 12 shows an outsert 1200 that has a first set 1205 and a second set 1210 of grooves on respective portions of its outer surface, which facilitate airflow around the outsert 1200 during flight.

What is claimed is:

1. A device for attaching an arrowhead to an arrow shaft, comprising:
an outsert comprising a hollow threaded portion; and
a cylindrical insert comprising a hollow portion.

2. The device of claim 1, wherein the outsert comprises a ceramic, a composite, or a metal alloy.

3. The device of claim 2, wherein the metal alloy comprises steel, stainless steel, an aluminum alloy, a titanium alloy, or a magnesium alloy.

4. The device of claim 1, wherein the cylindrical insert comprises a polymer.

5. The device of claim 4, wherein the polymer comprises a nylon, acrylonitrile butadiene styrene (ABS) plastic, polyethylene, polypropylene, or polyoxymethylene (POM).

6. The device of claim 1, wherein an interior of the hollow portion of the cylindrical insert is unthreaded.

7. The device of claim 1, wherein the outsert is secured to the cylindrical insert by an adhesive.

8. The device of claim 7, wherein the adhesive comprises an epoxy, a hot-melt, a cyanoacrylate, or a urethane.

9. The device of claim 1, wherein the cylindrical insert is molded to the outsert.

10. The device of claim 1, wherein the cylindrical insert comprises a solid cylindrical portion.

11. The device of claim 1, wherein the cylindrical insert extends past an edge of the outsert.

12. The device of claim 1, wherein an inner diameter of the hollow portion of the cylindrical insert is between approximately 0.135 inches and approximately 0.150 inches.

13. The device of claim 1, wherein an outer diameter of the cylindrical insert is between approximately 0.165 inches and approximately 0.210 inches.

14. The device of claim 1, wherein the outsert comprises a first hollow cylindrical portion on a first side of the hollow threaded portion and a second hollow cylindrical portion on a second side of the hollow threaded portion.

15. The device of claim 14, wherein the first hollow cylindrical portion has an inner diameter between approximately 0.25 inches and approximately 0.36 inches, and the second hollow cylindrical portion has an inner diameter between approximately 0.135 inches and approximately 0.150 inches.

16. The device of claim 14, wherein a thickness of the cylindrical insert is between approximately 0.010 inches and approximately 0.040 inches.

17. A method for manufacturing a device for attaching an arrowhead to an arrow shaft, comprising:
injection molding a polymer into an outsert comprising a hollow threaded portion, a first hollow cylindrical portion on a first side of the hollow threaded portion, and a second hollow cylindrical portion on a second side of the hollow threaded portion,
wherein the injection-molded polymer forms a cylindrical insert bonded to an interior of the second hollow cylindrical portion of the outsert.

18. The method of claim 17, wherein the injection-molded polymer comprises a nylon, acrylonitrile butadiene styrene (ABS) plastic, polyethylene, polypropylene, or polyoxymethylene (POM).

19. The method of claim 18, wherein injection molding the polymer comprises dispersing particles of lead, bismuth, or tungsten throughout the polymer.

20. The method of claim 17, wherein the outsert comprises steel, stainless steel, an aluminum alloy, a titanium alloy, or a magnesium alloy.

21. A method for attaching an arrowhead to an arrow shaft, comprising:
inserting a cylindrical insert into the arrow shaft;
inserting the arrow shaft into a first hollow cylindrical portion of an outsert;
inserting the arrowhead into a second hollow cylindrical portion of the outsert;
screwing a threaded portion of the arrowhead into a hollow threaded portion of the outsert.

22. The method of claim 21, further comprising tapping a hollow portion of the cylindrical insert by screwing the threaded portion of the arrowhead into the hollow portion of the cylindrical insert.

23. The method of claim 21, further comprising securing the cylindrical insert to the outsert with an adhesive.

24. The method of claim 23, wherein the adhesive comprises an epoxy, a hot-melt, a cyanoacrylate, or a urethane.

25. The method of claim 21, further comprising securing both the cylindrical insert and the outsert to the arrow shaft with an adhesive.

26. The method of claim 25, wherein the adhesive comprises an epoxy, a hot-melt, a cyanoacrylate, or a urethane.

27. A method for attaching an arrowhead to an arrow shaft, comprising:
inserting the arrow shaft into a first hollow cylindrical portion of an outsert, the first hollow cylindrical portion of the outsert containing an injection-molded polymer insert;
inserting the arrowhead into a second hollow cylindrical portion of the outsert; and
screwing a threaded portion of the arrowhead into a hollow threaded portion of the outsert.

28. The method of claim 27, further comprising tapping a hollow portion of the injection-molded polymer insert by screwing the threaded portion of the arrowhead into the hollow portion of the injection-molded polymer insert.

29. The method of claim 27, further comprising securing both the injection-molded polymer insert and the outsert to the arrow shaft with an adhesive.

30. The method of claim 29, wherein the adhesive comprises an epoxy, a hot-melt, a cyanoacrylate, or a urethane.
